(19) United States
(12) Patent Application Publication
(10) Pub. No.: US 2006/0164832 A1
(43) Pub. Date: Jul. 27, 2006

(54) Jewelry lamp

(75) Inventors: Shu-Shoung Kuo, Taipei City (TW); Shu-Chern Kuo, Taipei City (TW)

Correspondence Address: Troxell Law Office Pllc;Suite 1404, 5205 Leesburg Pike, Falls Church, VA, 22041, US

(73) Assignee: Shu-Chern KUO

(21) Appl. No.: 11/217,498

(22) Filed: Sep. 2, 2005

(30) Foreign Application Priority Data
Jan. 25, 2005 (TW) 094201376

(51) Int. Cl. F21V 9/00

(52) U.S. Cl. 362/231

(57) ABSTRACT

A jewelry lamp is provided, wherein when white light illuminants and chromatic light illuminants emit light at the same time, light emitted from the white light illuminants is a white light with a constant range of spectrum, which turns into a full spectrum white light after mixing with chromatic light with specific spectra emitted from the chromatic light illuminants. When the full spectrum white light is shining on an object, it has a superior chromogenesis and color rendering, so as to enable the object viewed by a human eye or a camera to manifest a vivid color. On the other hand, when the full spectrum white light is shining on an object such as a diamond, a reflection effect with a chromatic color can be generated due to a variation of angles of incidence of each chromatic light.

### BACKGROUND OF THE INVENTION

(a) Field of the Invention

The present invention relates to a jewelry lamp, and more particularly to a jewelry lamp wherein when white light illuminants and chromatic light illuminants emit light at the same time.

(b) Description of the Prior Art

As shown in FIG. 1, an incandescent lamp A includes a filament B sealed in a vacuum glass sphere. A high temperature from heating of a resistor of the filament B turns the lamp into a status of incandescence for emitting light upon passing through an electric current. In order to create a gentle light from the incandescent lamp A, most of the glass sphere is processed with a weak acid or is made into a frosted glass, so as to diffuse light emitted from the filament, with an efficiency of about 111 m/N to 221 m/W. In addition, color temperature of all parts of the incandescent lamp A in use is very high, costing a lot of electricity.

Moreover, color temperature of light emitted is generally low, and within the light viewed by a fresh eye is mostly a red and an orange light, along with some part of yellow light, which generally belong to warm colors. Fraction of light in other cool colors is extremely low. Therefore, when the light is shining on an object, it is easy for the object to manifest a reddish or orange, which means that the chromogenesis and color rendering of the light is inferior.

Referring to FIG. 2, an energy saving lamp C includes an electrode C2 on which coated an electron emitter such as potassium oxide or calcium oxide, and a lamp shade C1 inside which coated a fluorescence material D. An inner space of the lamp shade C1 is suctioned to form a vacuum space, followed by adding a filling gas such as argon or nitrogen and a small amount of mercury. When a voltage is applied between electrodes C2, electrons start to be emitted from the electrodes C2, and are continuously ejected to collide with mercury atoms in the lamp shade C1, thereby emitting a short-wave ultraviolet ray. A visible light is emitted when the ultraviolet ray is excited to the fluorescent material D.

However, color temperature of the light emitted is generally high, and within the light viewed by a fresh eye is mostly a light in cool colors such as blue or a purple light, with very few of light in other warm colors. Therefore, when the light is shining on an object, it is usually for the object to manifest an inferior vividness and an unclear coloration.

Accordingly, how to provide a lamp with superior chromogenesis and color rendering is a problem which needs to be solved by the inventor.

### SUMMARY OF THE INVENTION

The present invention is to provide a jewelry lamp, and more particularly to a jewelry lamp wherein when white light illuminants and chromatic light illuminants emit light at the same time, a light emitted from a mixing device is a white light with a full spectrum, after a white light with a constant range of spectrum emitted from the white light illuminants is mixed with a chromatic light with a specific spectrum emitted from the chromatic light illuminants.

Upon lightening, a vivid color is generated on an object viewed by a human eye or a camera due to superior chromogenesis and color rendering of the full spectrum white light.

As a variation of positions of chromatic light illuminants before mixing, the full spectrum white light contains chromatic light of various angles of incidence, which enables the chromatic light within the full spectrum white light to generate a scattering of a variety of chromatic light, upon shining on a reflector such as a jewelry or a diamond.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a prior art perspective view of a conventional incandescent lamp.

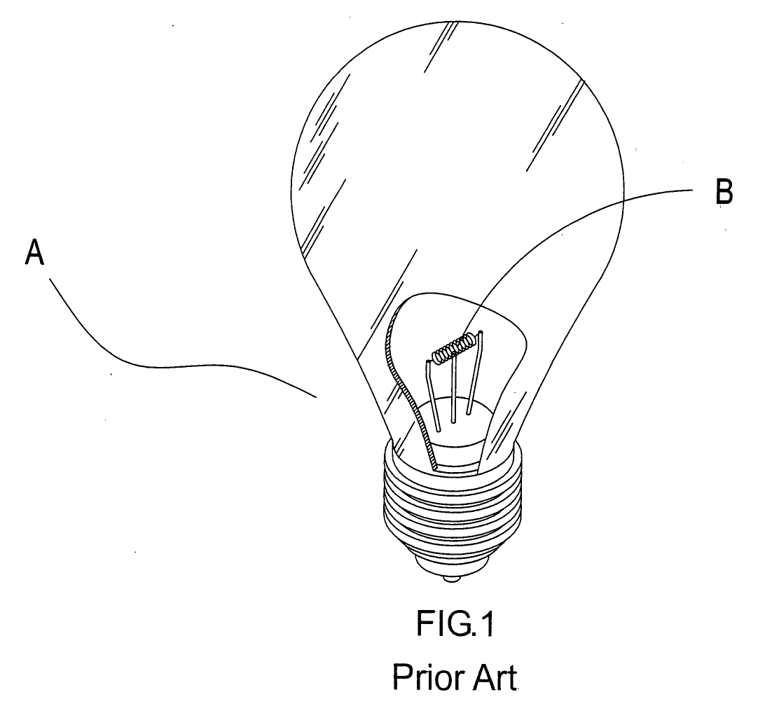

FIG. 2 shows a prior art perspective view of an energy saving lamp.

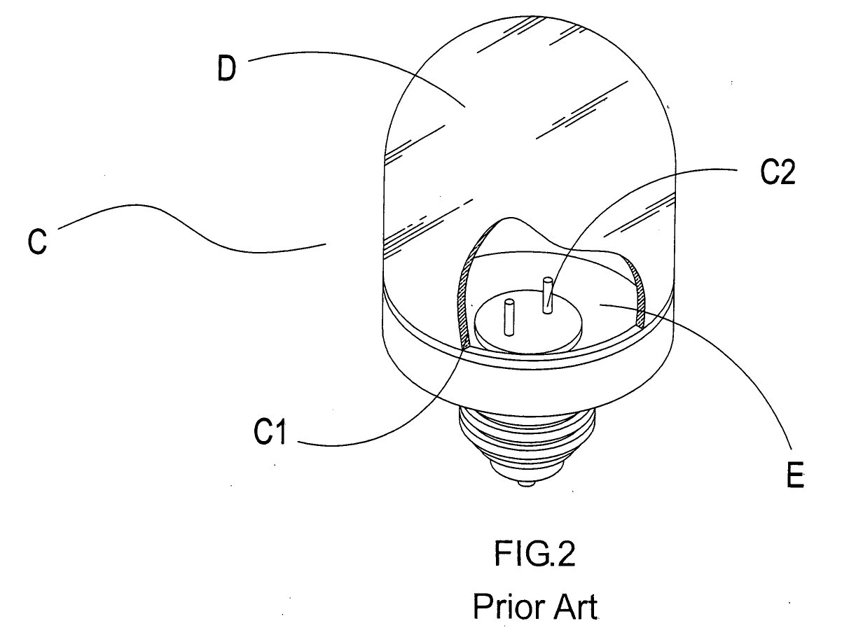

FIG. 3 shows a perspective view of the present invention.

FIG. 4 shows a perspective view of a circuit board of the present invention.

FIG. 5 shows a schematic view of an implementation of the present invention.

FIG. 6 shows a schematic view of another implementation of the present invention.

### DETAILED DESCRIPTION OF THE PREFERRED EMBODIMENTS

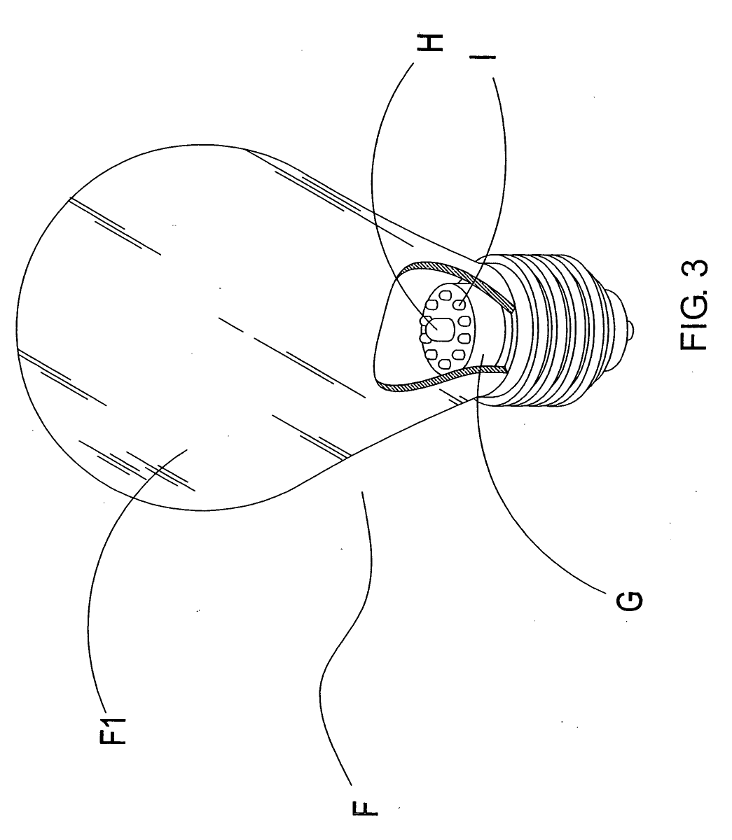

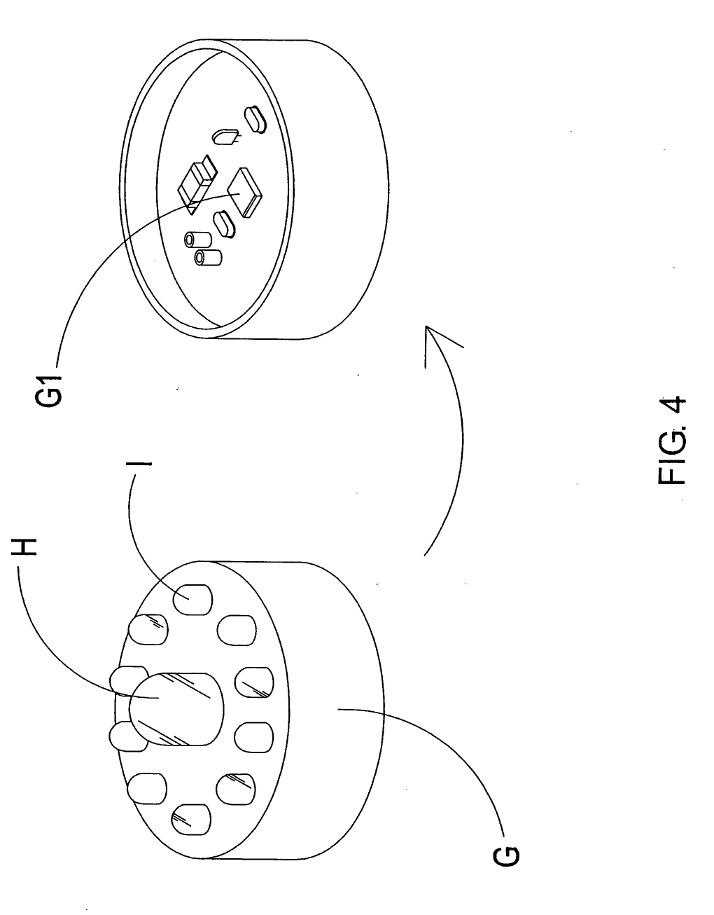

Referring to FIG. 3 and FIG. 4, a jewelry lamp F comprises a mixing device F1 and a circuit board G, wherein a driving circuit G1, white light illuminants H, and chromatic light illuminants I arranged in various locations are installed on the circuit board. The driving circuit G1 is used to control lightening of the white light illuminants H and the chromatic light illuminants I.

When the white light illuminants H and the chromatic light illuminants I emit light at the same time, a light emitted through the mixing device F1 is a full spectrum white light, after a white light With a constant range of spectrum emitted from the white light illuminants H is mixed with a chromatic light with a specific spectrum emitted from the chromatic light illuminants I.

Upon lightening, a vivid color is generated on an object viewed by a human eye or a camera due to superior chromogenesis and color rendering of the full spectrum white light, and when applied on an object with light transmitting and splitting functions such as a diamond, as the full spectrum white light contains chromatic light of various angles of incidence, the chromatic light within the full spectrum white light can generate a scattering of a variety of chromatic light, corresponding to a variation of angles of reflection, after transmitting through the aforementioned object.

In addition, as the white light illuminants H and the chromatic light illuminants I have a small size and cost low electricity, they will not generate high heat in long term usage, thereby having an advantage of energy saving.

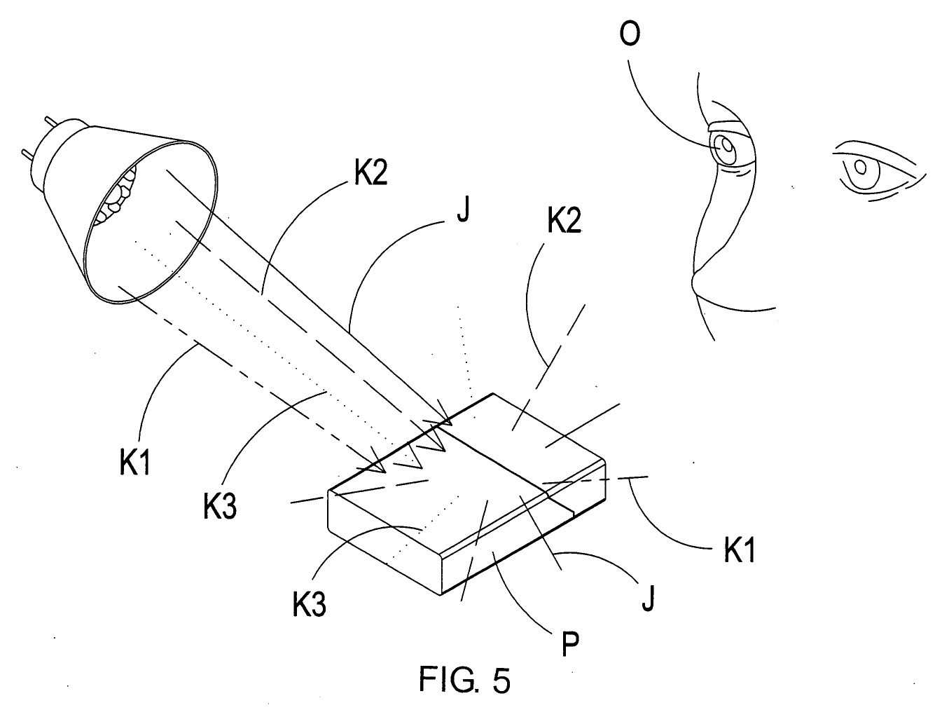

Referring to FIG. 3 and FIG. 5, a plurality of White light illuminants H and a plurality of chromatic light illuminants I inside a lamp F emit light at the same time. Before transmitting out from a mixing device F1, white light J emitted from the white light illuminants H is transmitting along a same path with chromatic light K1, K2, and K3 emitted from chromatic light illuminants I, and with mutually overlapped spectra. After passing out from the mixing device F1, the light turns into a full spectrum white light and enters a human eye O and shines on an object P. At this time, the full spectrum white light L that is shining on the object P is reflected into the human eye O. As the full spectrum white light L consists of a range of spectrum of all of the chromatic light within a visible light, the object P manifests a superior vividness upon being viewed by a human.

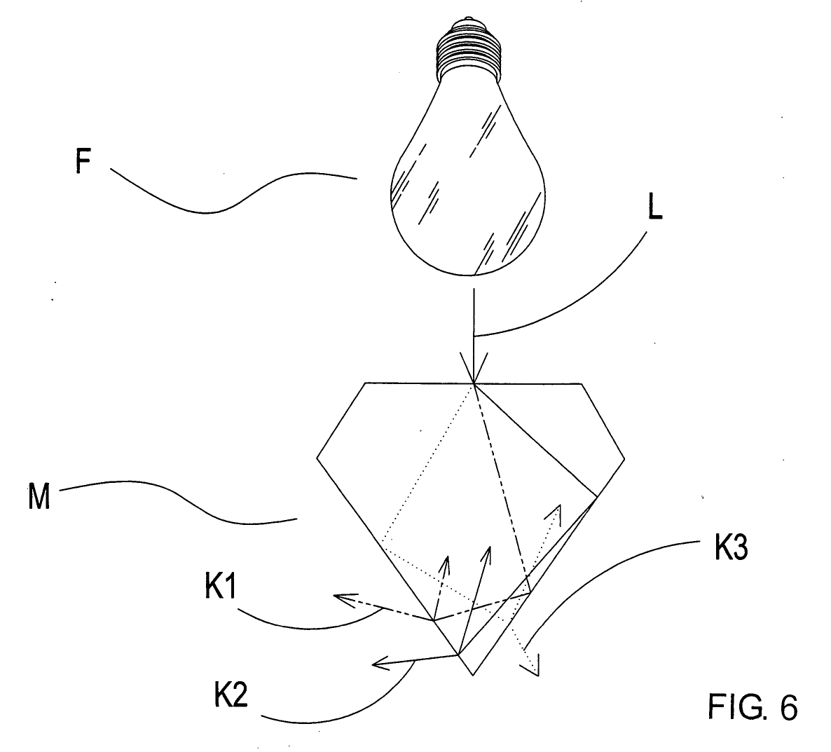

Referring to FIG. 6, after a full spectrum white light L emitted from a lamp F enters a diamond M, a variety of chromatic light K1, K2, and K3 are reflected respectively due to a variety of angles of reflection. In addition, when each reflected light contacts with the diamond M again, a reflection and refraction will be induced at a contact surface respectively. Therefore, the diamond H will generate a variety of chromatic light after a plurality of various and continuous reflection and refraction of the chromatic light K1, K2, and K3.

To further manifest the advancement and practicability of the present invention, the present invention is compared with a conventional application as follow:

Shortcomings of a conventional application

Most of the conventional jewelry lamp uses an incandescent lamp as a lightening source:
1. Color temperature of light emitted is generally low, which is easy for an object being shinned on to manifest a yellowish or reddish color.
2. A wavelength of wave section inside the light is focusing on a specific portion.
3. Accordingly, an effect of chromatic light generated is limited when the light is shining on a reflector such as a jewelry or diamond.

Advantages of the present invention:
1. Light is a full spectrum white light.
2. Color temperature of the light is uniform.
3. It has a superior chromogenesis and color rendering.
4. It costs low electricity.
5. It has an advancement and practicability.
6. It can promote an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A jewelry lamp including a mixing device and a circuit board, wherein the circuit board is equipped with a driving circuit, white light illuminants, and chromatic light illuminants, and the driving circuit is used to control the light emission of the white light illuminants and the chromatic light illuminants; at least one set of the white light illuminants installed on the circuit board, surrounded by at least one set of chromatic light illuminants arranged at various locations; the aforementioned chromatic light illuminants emitting chromatic light with various angles of incidence, and still turning into a white light after mixing with the white light, upon emitting light; a scattering of variety of chromatic light generated through a variation of angles of reflection of the chromatic light upon shining on an object.

2. The jewelry lamp according to claim 1, wherein the white light illuminant is further a white light diode, a cool light slice of white light, and a related white light illuminating device with white light formed by mixing various chromatic light.

3. The jewelry lamp according to claim 1, wherein the chromatic light illuminant is further a chromatic light diode, a cool light slice of chromatic light, and a related chromatic light illuminating device.
